(19) United States
(12) Patent Application Publication
(10) Pub. No.: US 2005/0247106 A1
(43) Pub. Date: Nov. 10, 2005

(54) Relative humidity sensor enclosed with ceramic heater

(75) Inventors: Jamie W. Speldrich, Freeport, IL (US); Michael P. Farrey, Freeport, IL (US)

Correspondence Address: Kris T. Fredrick;Honeywell International, Inc., Attorney, Intellectual Property, 101 Columbia Rd., P.O. Box 2245, Morristown, NJ, 07962, US

(73) Assignee: Honeywell International, Inc.

(21) Appl. No.: 10/858,983

(22) Filed: Jun. 2, 2004

Related U.S. Application Data
(60) Provisional application No. 60/568,591, filed on May 6, 2004.

(51) Int. Cl. G01N 7/00

(52) U.S. Cl. 73/29.01

(57) ABSTRACT

Sensor systems and methods are disclosed herein. A relative humidity sensor can be associated with one or more ceramic heating elements configured from a porous material. In general, a perimeter of the relative humidity sensor is surrounded with a relatively conductive material. A resistive material surrounds one or more of the ceramic heating elements, such that air that is saturated with water vapor passes through the porous material of the ceramic heating element(s). Water vapor can therefore be heated by the ceramic heating element(s) in order to evaporate water droplets associated with the water vapor and thereby reduce relative humidity to a measurable level. The porous material of the ceramic heating element(s) can be provided via a plurality of laser drilled holes to create such porosity.

### REFERENCE TO RELATED APPLICATION

This patent application claims priority under 35 U.S.C. § 119(e) to provisional patent application Ser. No. 60/568,591 entitled “Sensor Methods and Systems,” which was filed on May 6, 2004, the disclosure of which is incorporated herein by reference.

### GOVERNMENT INTERESTS

The United States government may have rights in the invention described herein made in the performance of work under Department of Energy (DOE) Cooperative Agreement DE-FC36-02AL67615.

### TECHNICAL FIELD

Embodiments are generally related to sensor methods and systems. Embodiments are also related to humidity sensors and moisture sensing elements thereof, flow sensors, pressure sensors, thermal sensors and temperatures sensors. Embodiments are additionally related to sensors utilized in fuel cell systems, such as, for example, PEM fuel cell applications.

### BACKGROUND OF THE INVENTION

Humidity sensors, flow sensors, pressure sensors and temperatures sensors and the like can be utilized in a variety of sensing applications. With respect to humidity sensors, for example, providing suitable instruments for the measurement of relative humidity (RH) over wide RH ranges (e.g., 1%-100%) continues to be a challenge. Humidity sensors can be implemented in the context of semiconductor-based sensors utilized in many industrial applications. Solid-state semiconductor devices are found in most electronic components today. Semiconductor-based sensors, for example, are fabricated using semiconductor processes.

Many modern manufacturing processes, for example, generally require measurement of moisture contents corresponding to dew points between −40° C. and 180° C., or a relative humidity between 1% and 100%. There is also a need for a durable, compact, efficient moisture detector that can be used effectively in these processes to measure very small moisture content in gaseous atmospheres.

Humidity can be measured by a number of techniques. In a semiconductor-based system, humidity can be measured based upon the reversible water absorption characteristics of polymeric materials. The absorption of water into a sensor structure causes a number of physical changes in the active polymer. These physical changes can be transduced into electrical signals which are related to the water concentration in the polymer and which in turn are related to the relative humidity in the air surrounding the polymer.

Two of the most common physical changes are the change in resistance and the change in dielectric constant, which can be respectively translated into a resistance change and a capacitance change. It has been found, however, that elements utilized as resistive components suffer from the disadvantage that there is an inherent dissipation effect caused by the dissipation of heat due to the current flow in the elements necessary to make a resistance measurement. The result is erroneous readings, among other problems.

Elements constructed to approximate a pure capacitance avoid the disadvantages of the resistive elements. It is important in the construction of capacitive elements, however, to avoid the problems that can arise with certain constructions for such elements. In addition, there can also be inaccuracy incurred at high relative humidity values where high water content causes problems due to excessive stress and the resulting mechanical shifts in the components of the element. By making the component parts of the element thin, it has been found that the above-mentioned problems can be avoided and the capacitance type element can provide a fast, precise measurement of the relative humidity content over an extreme range of humidity as well as over an extreme range of temperature and pressure and other environmental variables.

Humidity sensing elements of the capacitance sensing type usually include a moisture-insensitive, non-conducting structure with appropriate electrode elements mounted or deposited on the structure along with a layer or coating of dielectric, highly moisture-sensitive material overlaying the electrodes and positioned so as to be capable of absorbing water from the surrounding atmosphere and reaching equilibrium in a short period of time. Capacitive humidity sensors are typically made by depositing several layers of material on a substrate material. An example of a humidity sensor is disclosed in U.S. Pat. No. 6,724,612, entitled “Relative Humidity Sensor with Integrated Signal Conditioning,” which issued to Davis et al on Apr. 20, 2004, and issued to Honeywell International, Inc. U.S. Pat. No. 6,724,612 is incorporated herein by reference.

A limitation of humidity sensor is the relative humidity (RH) can be measured up to 100% RH above which the sensor reaches saturation. At levels higher than 100% RH, minute water droplets are formed in suspension (fog, a.k.a. two-phase flow) and the sensor may fail to operate. The technique used in this invention enables measurement of greater than 100% RH with a sensor that is capable of only 0 to 100% RH sensitivity by making a controlled, heated environment in the vicinity of the sensing area which can evaporate small water droplets and reduce RH to a measurable level.

This technique depends on a controlled, uniform temperature at the sensing area of the RH sensor which is particularly is critical because relative humidity varies with temperature for the same mole fraction of water vapor in the air. With respect to sensor housing and sensor parts thereof, flow and diffusion of humid ambient air and differences between the coefficients of thermal conductivity of the components will affect the uniformity of the temperature at the sensing surface can cause a shift in output over temperature, flow, and humidity changes. Therefore, a variety of sensor configurations, systems, and methods are disclosed herein, which attempt to rectify such problems.

### BRIEF SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect of the present invention to provide for improved sensor methods and systems.

It is another aspect of the present invention to provide for improved relative humidity sensor methods and systems.

It is a further aspect of the present invention to provide for improved temperature, pressure and flow sensing methods and systems.

The aforementioned aspects of the invention and other objectives and advantages can now be achieved as described herein. Sensor systems and methods are disclosed herein. In accordance with a first embodiment, an RH sensor can be associated with one or more heating elements, wherein a perimeter of the RH sensor is surrounded with a relatively conductive material. A thin substrate material can surround and laminate the heating element, such that the heating element is perforated to permit humid air to pass through the heating element and wherein the heating element is assembled slightly offset from a surface of the RH sensor.

Air that is saturated with two phase flow of water vapor and minute droplets can then pass through and be heated by the heating element in order to evaporate water droplets associated with the water vapor to thereby reduce relative humidity to a measurable level. An additional heating element can be bonded to a base of the RH sensor. The thin substrate material can be configured from a polymide polymer, such as Kapton® material. Additionally, a filter material can be located slightly offset from the RH sensor to create a thin space of stagnant air adjacent to the RH sensor. The filter material may be a hydrophobic material such as Goretex® which can limit the size of water droplets, which pass through and therefore reduce the volume of water needing to be evaporated.

In accordance with a second embodiment, a RH sensor can be associated with one or more ceramic heating element, wherein a perimeter of the RH sensor is surrounded with a relatively conductive material. A resistive material can surround and laminate the ceramic heating element. The ceramic heating element can be configured from a porous material, wherein air that is saturated with water vapor passes through and is heated by the ceramic heating element in order to evaporate water droplets associated with the water vapor to thereby reduce relative humidity to a measurable level. One or more other heating elements can be bonded to the base of the RH sensor. The porous material forming the ceramic heating element can be formed by providing a plurality of laser drilled holes to create porosity thereof. Additionally, a filter material can be located slightly offset from the RH sensor to create a thin space of stagnant air adjacent to the RH sensor.

In accordance with a third embodiment, a RH sensor can be associated with one or more heating elements, wherein the RH sensor is surrounded by a sheet of porous resistive material in a woven or perforated pattern or state. The porous heating element can be configured to permit humid air to pass through the porous heating element. The porous heating element can be further assembled slightly offset from a surface of the RH sensor, wherein air that is saturated with water vapor passes through and is heated by the porous heating element in order to evaporate water droplets thereof to thereby reduce relative humidity to a measurable level. Additionally, a flat heating element can be bonded to the base of the RH sensor to conduct heat and insure uniform heating about the RH sensor. The porous resistive material can be formed from material such as tantalum or nichrome. A filter material can also be located slightly offset from the RH sensor to create a thin space of stagnant air adjacent to the RH sensor

In accordance with a fourth embodiment, an RH sensor can be associated with one or more heating elements, wherein a perimeter of the RH sensor is surrounded with a relatively conductive material. A thin substrate material can surround and laminate the heating element, such that the heating element is perforated to permit humid air to pass through the heating element and wherein the heating element is assembled slightly offset from a surface of the RH sensor.

An additional heating element can be bonded to a base of the RH sensor. The thin substrate material can be configured from a polymide polymer, such as Kapton® material. Additionally, a filter material can be located at vent openings in the RH sensor housing to create a relatively large space of stagnant air adjacent to the RH sensor. The filter material may be a hydrophobic material such as Goretex® which can limit the size of water droplets which pass through and therefore reduce the volume of water entering the sensor housing and needing to be evaporated.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a block diagram of a sensor system 100, which can be implemented in accordance with one embodiment of the present invention;

FIG. 2 illustrates a block diagram of a sensor system, in accordance with an alternative embodiment of the present invention;

FIG. 3 illustrates a block diagram of a sensor system, in accordance with an alternative embodiment of the present invention;

FIG. 4 illustrates a block diagram of a sensor system including a heater laminated with a polyimide polymer, in accordance with an alternative embodiment of the present invention;

FIG. 5 illustrates a block diagram of a system, which can be implemented in accordance with an alternative embodiment of the present invention;

FIG. 6 illustrates a block diagram of a sensor system that includes an RH sensor and a heater in association with one or more hydrophobic filters at housing vent openings thereof, in accordance with an alternative embodiment of the present invention;

FIG. 7 illustrates a block diagram of a sensor system including an RH sensor surrounded by a porous resistive material in a woven or perforated state, in accordance with an alternative embodiment of the present invention;

FIG. 8 illustrates a perspective view of a fuel cell humidity sensor, which can be implemented in accordance with an alternative embodiment of the present invention; and

FIG. 9 illustrates a perspective view of a fuel cell humidity sensor depicted in FIG. 8, including a PCB/connector assembly and a plastic probe, in accordance with an alternative embodiment of the present invention.

### DETAILED DESCRIPTION OF THE INVENTION

The particular values and configurations discussed in these non-limiting examples can be varied and are cited merely to illustrate at least one embodiment of the present invention and are not intended to limit the scope of the invention.

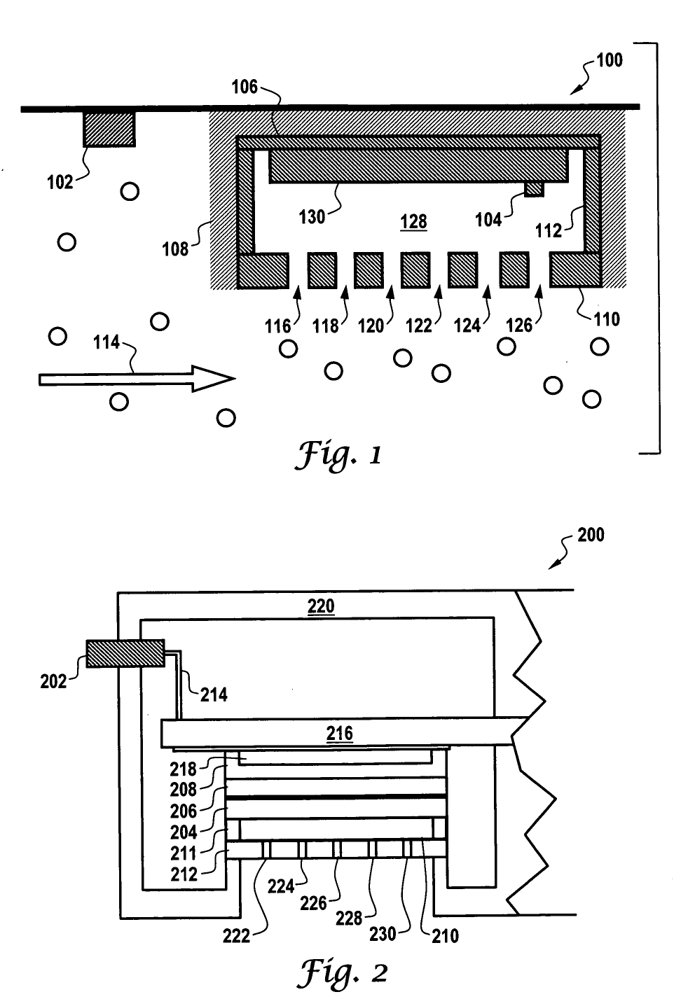

FIG. 1 illustrates a block diagram of a sensor system 100, which can be implemented in accordance with one embodiment of the present invention. System 100 generally includes an ambient temperature sensor 102 in association with an RH sensor 130 and a porous heater 110. An insulating material or insulator 108 can be located adjacent to another heater 106. A temperature sensor 104 can be located adjacent RH sensor 130 to measure temperature as close as possible to the RH sensor 130 area.

A gap 128 can be formed between RH sensor 130 and porous heater 110. A heater or conductive material 112 can be located between heater 106 and porous heater 110. In FIG. 1, the flow of air, water vapor and/or fog is generally indicated by arrow 114. Porous heater 110 can be formed such that a plurality of holes 116, 118, 120, 122, 124, 126 thereof permit the water vapor and/or fog represented by arrow 114 to pass through porous heater 110 for reduction of water droplets thereof. Thus, air that is supersaturated with water vapor and/or fog can pass through porous heater 110, such that the water droplets are heated and evaporated to reduce relative humidity to a measurable level.

System 100 can be implemented to control temperature and reduce the relative humidity associated with RH sensor 130. In general, when humidity is greater than 100%, the atmosphere becomes two-phase, meaning that a mixture of water vapor and minute water droplets (e.g., fog) is present. Conventional RH sensing systems are limited to a relative humidity sensing range of 0% to 100%, which includes only water vapor without droplets. To overcome such conventional limitations, system 100 in essence implements a “mini-oven” approach, wherein water droplets are heated as they pass through porous heater 110. Such a technique creates a small environment that maintains a humidity level within a required sensing range. The actual humidity level at the ambient temperature can then be calculated. Such a calculation can be accomplished by measuring the temperature at the surface of the humidity sensor and also at the ambient temperature. The humidity level at the ambient temperature can then be inferred.

FIG. 2 illustrates a block diagram of a sensor system 200, in accordance with an alternative embodiment of the present invention. System 200 generally includes an RH sensor 204. RH sensor 204 can be located between a conductive spacer 211 and a heater 2060. Heater 206 can be located adjacent an insulating spacer 208. An ambient temperature sensor can also be implemented in association with insulating spacer 208, heater 210 and RH sensor 204.

A ceramic substrate 212 can be located adjacent conductive spacer 211. Ceramic substrate 212 can function as a substrate of a resistive heater 210. Depending upon a desired implementation, resistive heater 210 can function as a porous heater. In such a configuration, the ceramic substrate 212 functions as a porous ceramic heating element assembled with a relatively thermally conductive material (e.g., conductive spacer 211) about the perimeter of the RH sensor 204. Another heating element (e.g., heater 206) can be assembled to the base of RH sensor 204 to ensure uniform heating at the sensing surface thereof. Air that is supersaturated with water vapor and/or fog can therefore pass through the porous ceramic material of ceramic substrate 212, so that water droplets thereof are heated from the fog and/or water vapor and evaporated to reduce RH to a measurable level.

An electrical connection 214 may extend from ambient temperature sensor 202 to a printed circuit board (PCB) 216, which can function as a PCB for all or most electrical components of system 200. An air gap 218 can be formed between PCB 216 and insulating spacer 2081 to create an insulator, which helps to control power dissipation and temperature uniformity. An external housing portion 220 can surround components such as PCB 218, electrical connection 214, air gap 218 and so forth. Ambient temperature sensor 202 can protrude, however, through housing portion 220. A plurality of holes 222, 224, 226, 228, 230 can be implemented as laser drilled holes in the ceramic substrate 212 to effectively make the ceramic substrate porous. The porosity may be also accomplished with a ceramic or other material that is powderized, pressed, and sintered to a low density.

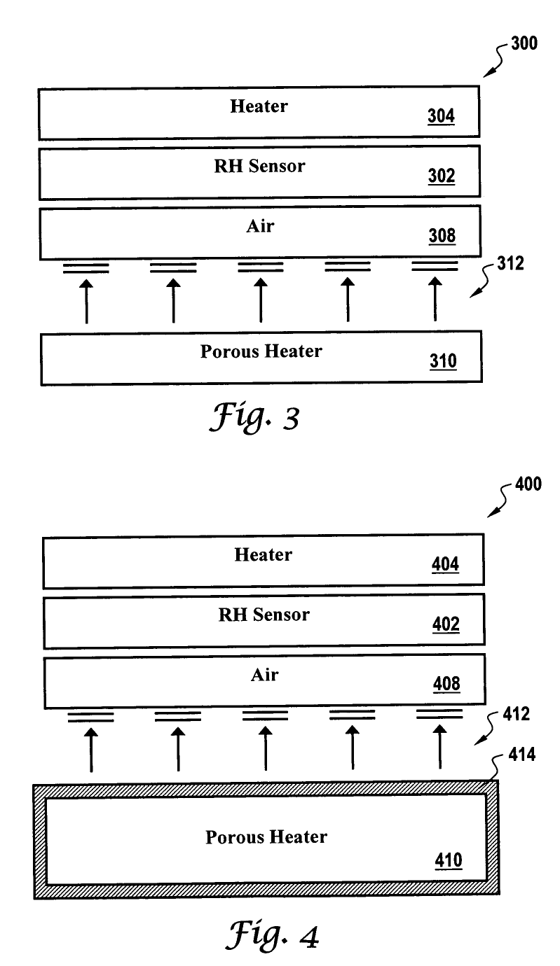

FIG. 3 illustrates a block diagram of a sensor system, in accordance with an alternative embodiment of the present invention. FIG. 3 illustrates a block diagram of a sensor system 300, in accordance with an alternative embodiment of the present invention. RH sensor 302 can be located between a heater 304 and a porous heater 310, which as indicated by arrows 312, can warm or heated air, represented by block 308 in FIG. 3.

In general, RH sensor 202 of FIG. 2 and RH sensor 302 of FIG. 3 require uniform heating about the humidity sensor in order to control the temperature at the surface of the sensor die (e.g., sensor 111 and 113 of FIG. 1) with increasing accuracy. Uniform temperature is critical because relative humidity can vary with temperature for the same mole fraction of water vapor in the air. In order to satisfy such requirements, a system, such as that depicted in FIG. 4 can be implemented.

FIG. 4 illustrates a block diagram of a sensor system 400 including a heater 410 laminated with a polyimide polymer 414, in accordance with an alternative embodiment of the present invention. System 400 allows for temperature control of the RH sensor 402 by utilizing a heater 410, which is formed from a resistive material that is laminated with a thin substrate material such as polyimide polymer 414. Heater 410 can be pre-formatted to allow humid air as indicated by arrows 412 to pass through the porous material of heater 410. A filter material (not shown in FIG. 4) can be located slightly offset from the RH sensor 402 to create a thin space of stagnant air, represented in FIG. 4 by block 408.

Another heating element, such as a heater 404 can be bonded to a base of RH sensor 402 to insure uniform temperature at the sensing surface thereof. Air that is supersaturated with water vapor and fog, for example, can then pass through the filter material of porous heater 414 and heating elements thereof, so that water droplets are heated and evaporated to reduce relative humidity to a measurable level. Polyimide polymer 414 can be, for example, a Kapton® material. Note that Kapton® is a trademark of the DuPont™ Corporation. A Kapton® material, in film form, can provide an enhanced dielectric strength in very thin cross sections and very good bonding and heat transfer capabilities. Heater 410 can therefore be implemented as a Kapton® type heater. Note that resistive heater 210 of FIG. 2 can be implemented as a Kapton® type heater or a heater formed of a polyimide polymer, depending upon design considerations.

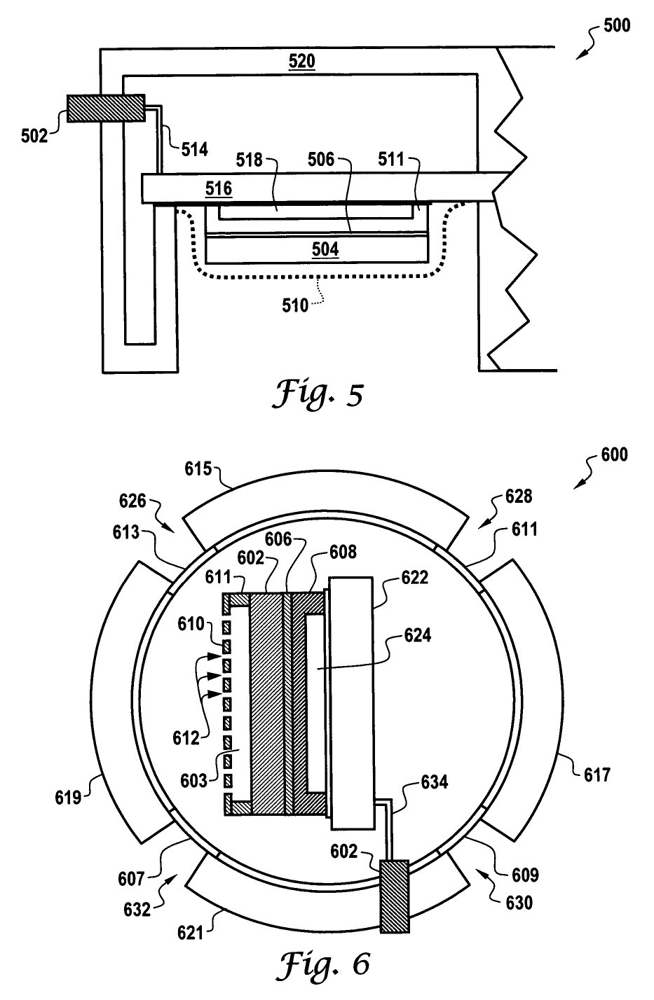

FIG. 5 illustrates a block diagram of a system 500, which can be implemented in accordance with an alternative embodiment of the present invention. System 500 generally includes an RH sensor 504, which is disposed adjacent a heater 506, which in turn is located adjacent an insulating spacer 511. RH sensor 504, heater 506 and insulating spacer 511 can be implemented in association with an ambient temperature sensor 502. A porous heater 510 can then be disposed in such a manner that porous heater 510 surrounds RH sensor 504, heater 506 and insulating spacer 511. An electrical connection 514 may extend from ambient temperature sensor 502 to printed circuit board (PCB) 516, which functions as a PCB for all or most electrical components of system 500.

An air gap 518 can be formed between PCB 516 and insulating spacer 511 to create an insulator, which helps to control power dissipation and temperature uniformity. An external housing portion 520 can surround components such as PCB 516, electrical connection 514, air gap 518, porous heater 510, RH sensor 506 and so forth. Ambient temperature sensor 502 can protrude, however, through housing portion 520.

FIG. 6 illustrates a block diagram of a sensor system 600 that includes an RH sensor 602 and a heater 607 in association with one or more hydrophobic filters 607, 609, 611, 613 at respective housing vent openings 632, 630, 628, 626 thereof, in accordance with an alternative embodiment of the present invention. A housing can be configured to include housing portions 615, 617, 621 and 621. Housing portions 615, 617, 621 and 621 of FIG. 6 are generally analogous to housing portions such as housing portion 220 of FIG. 2 and/or housing portion 520 of FIG. 5. System 600 can be utilized to control temperature and reduce humidity levels on an RH sensor 602. Porous heater 610 can be disposed opposite RH sensor 602. A gap 603 is generally located between porous heater 610 and RH sensor 602. An insulating spacer 608 is located adjacent a heater 606. One or more conductive spacers 611 can be disposed between porous heater 610 and RH sensor 602.

The hydrophobic filter 607, for example, can be located proximate or adjacent to housing portion 621. A printed circuit board (PCB) 622 can be located adjacent to insulating spacer 608. An air gap 624 can be located between PCB 622 and insulating spacer 608. Air gap 624 helps to control power dissipation and temperature uniformity. Air gap 624 is similar, for example, to air gap 218 of FIG. 2 and air gap 518 of FIG. 5. Electrical leads or electrical connection 634 connects the PCB 622 to RH sensor 602, which can also function as a temperature sensor. Electrical connection 634 is similar to respective electrical connections 214 and 514 of FIGS. 2 and 5. RH sensor 602 may function similar to respective sensors 202 and 505 of FIGS. 2 and 5.

The filter material for hydrophobic filter 607 can be configured as a material, such as a Goretex® material, which can limit the size of water droplets that pass through and therefore reduce the volume of water entering the sensor housing and needing to be evaporated. Finally, an ambient temperature sensor 602 can be implemented in association with heater 606, porous heater 610 and RH sensor 602. Filter material or filters 607, 609, 611, 613 can be located slightly offset to create a thin space of stagnant air.

Note that heater 610 can also be formed from a ceramic type heating element made porous, for example, via a plurality of laser drilled holes 612 formed in order to insure that such a ceramic type heating functions as a porous heating element. Air that is supersaturated with water vapor and fog can pass through the porous heater 610, heat the water droplets from the fog and/or water vapor and thereafter evaporate such water droplets to reduce RH to a measurable level.

Filters 607, 609, 611, 613, which are located at the perimeter of the housing formed by housing portions 615, 617, 621 and 621 are important feature that can be utilized in the even more control on the water allowed inside the housing is required. Filters 607, 609, 611, 613 can be implemented to partially block water droplets. Most Gore type filters totally block liquid. A requirement exists, however, to sense above 100% RH, which is referred to as “two-phase” or “in-trained” water. The design depicted in FIG. 6, however, shifts the DEW point, so that the RH sensor 602 can avoid the majority of the water droplets, but still be able to report adverse condition. A fuel cell, for example, should be 99% RH non-condensing 100% of the time. Dynamic conditions on operation and environments thereof allow an overshoot conditions resulting in an associated fuel stack becoming wet. The RH sensor 602 of system 600 therefore allows the control system to sense this and correct the condition in order to bring conditions back into control.

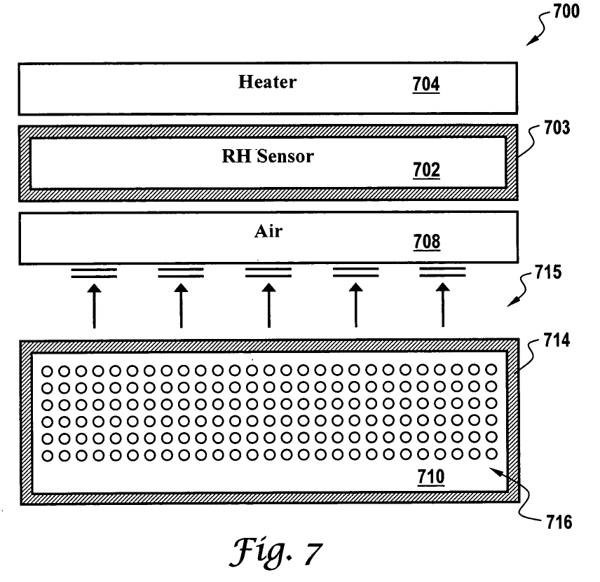

FIG. 7 illustrates a block diagram of a sensor system 700 including an RH sensor 702 surrounded by a porous resistive material 703 in a woven or perforated state, in accordance with an alternative embodiment of the present invention. System 700 generally includes a heating element 704 and a porous ceramic heating element 710, which can be laminated with a resistive material 714. System 700 can be implemented to control the temperature and reduce the relative humidity level on the RH sensor 702 by configuring RH sensor 702 with a small sheet of porous, resistive material 703, such as, for example, nichrome or tantalum, in a woven or perforated state, and placing such material 703 over RH sensor 702.

A filter, such as, for example, filter 607, 609, 611, 613 depicted in FIG. 6, can be placed offset from the formed heating element 710 to create an insulating layer of stagnant area, represented by arrows 715 and block 708 in FIG. 7. Another flat heating element 704 can be bonded to the base of RH sensor 702 to conduct heat from below and insure uniform heating around RH sensor 703. As air that is supersaturated with water vapor and fog passes through the formed heater or heating element 710, water droplets thereof are heated and evaporated. The relative humidity is then lowered to a measurable range.

The sensors disclosed herein can be applied to a number of important industrial and commercial devices and systems. One significant application of the sensors disclosed herein involves fuel cell applications. There are several kinds of fuel cells, but Polymer Electrolyte Membrane (PEM) fuel cells-also called Proton Exchange Membrane fuel cells-are the type typically used in automobiles. A PEM fuel cell uses hydrogen fuel and oxygen from the air to produce electricity. In general, most fuel cells designed for use in vehicles produce less than 1.16 volts of electricity, which is usually not sufficient to power a vehicle. Therefore, multiple cells must be assembled into a fuel cell stack. The potential power generated by a fuel cell stack depends on the number and size of the individual fuel cells that comprise the stack and the surface area of the PEM.

One example of a fuel cell application in which one or more of the methods and systems disclosed herein can be implemented is disclosed in U.S. Pat. No. 6,607,854, “Three-Wheel Air Turbocompressor for PEM fuel Cell Systems,” and issued to Rehg et al. on Aug. 19, 2003. U.S. Pat. No. 6,607,854 discloses a fuel cell system comprising a compressor and a fuel processor downstream of the compressor. In U.S. Pat. No. 6,607,854, a fuel cell stack is configured in communication with the fuel processor and compressor. A combustor is downstream of the fuel cell stack. First and second turbines are downstream of the fuel processor and in parallel flow communication with one another. A distribution valve is in communication with the first and second turbines. The first and second turbines are mechanically engaged to the compressor. A bypass valve is intermediate the compressor and the second turbine, with the bypass valve enabling a compressed gas from the compressor to bypass the fuel processor. U.S. Pat. No. 6,607,854 is assigned to Honeywell International, Inc., and is incorporated herein by reference.

Another example of a fuel cell application in which one or more of the methods and systems disclosed herein can be implemented is disclosed in U.S. Patent Publication No. 2003/0129468A1, “Gas Block Mechanism for Water Removal in Fuel Cells” to Issacci et al., which was published on Jul. 10, 2003 and is assigned to Honeywell International, Inc. U.S. Patent Publication No. 2003/0129468A1 is incorporated herein by reference. A further example of a fuel cell application in which one or more of the methods and systems disclosed herein can be implemented is disclosed in U.S. Patent Publication No. 2003/0124401A1, “Integrated Recuperation Loop in Fuel Cell Stack” to Issacci et al., which was published on Jul. 3, 2003 and is assigned to Honeywell International, Inc. U.S. Patent Publication No. 2003/0124401A1 is also incorporated herein by reference.

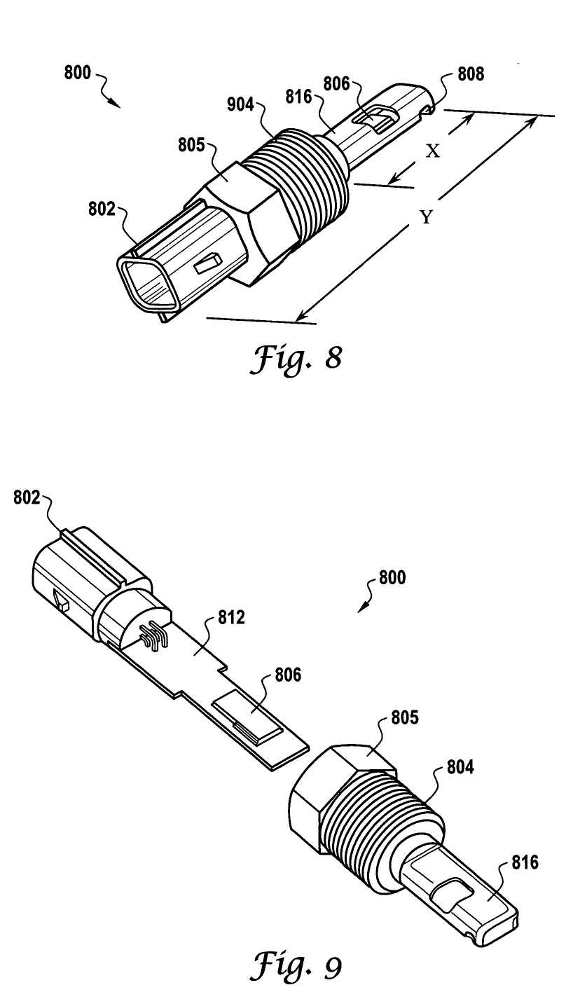

FIG. 8 illustrates a perspective view of a fuel cell humidity sensor 800, which can be implemented in accordance with an alternative embodiment of the present invention. FIG. 9 illustrates a perspective view of the fuel cell humidity sensor 800 depicted in FIG. 8, including a PCB/connector assembly 812 and a plastic probe 816, in accordance with an alternative embodiment of the present invention. Note that in FIGS. 8-9 identical or similar parts are generally indicated by identical reference numerals. Sensor 800 can be adapted for use with fuel systems and devices, and generally includes a male connector 802 which can be received by a metal nut 805 and a threaded portion 804.

A heated humidity sensor 806 can be located on PCB/connector assembly 812 and may be received by probe 816. PCB/connector assembly 812 is analogous, for example, to PCB 216 of FIG. 2, PCB 516 of FIG. 5 and/or PCB 622 of FIG. 6. A temperature sensor 808 can also be located along one end of probe 816. Temperature sensor 808 is generally analogous, for example, to ambient temperature sensors 102, 202, 502 of FIG. 1, FIG. 2, and FIG. 5. Similarly, humidity sensor 800 is analogous to and/or can be utilized to implement the systems 100, 200, 300, 400, 500, 600, and 700 respectively depicted in FIG. 1-7 herein.

Probe 816 may possess a length X and the entire length of fuel cell humidity sensor 800 may possess a length Y. A non-limiting measurement for length X can be, for example, 32 mm or 1.25 inches. A non-limiting measurement for length Y can be, for example, 84 mm or 3.30 in. It can be appreciated of course, that such measurements for X and Y are merely suggestions and that varying measurements can be implemented depending upon design considerations.

Based on the foregoing, it can be appreciated that varying sensor systems and methods are disclosed herein. In accordance with a first embodiment, an RH sensor can be associated with one or more heating elements, wherein a perimeter of the RH sensor is surrounded with a relatively conductive material. A thin substrate material can surround and laminate the heating element, such that the heating element is perforated to permit humid air to pass through the heating element and wherein the heating element is assembled slightly offset from a surface of the RH sensor.

Air that is saturated with two phase flow of water vapor and minute droplets can then pass through and be heated by the heating element in order to evaporate water droplets associated with the water vapor to thereby reduce relative humidity to a measurable level. An additional heating element can be bonded to a base of the RH sensor. The thin substrate material can be configured from a polymide polymer, such as Kapton® material. Additionally, a filter material can be located slightly offset from the RH sensor to create a thin space of stagnant air adjacent to the RH sensor. The filter material may be a hydrophobic material such as Goretex® which can limit the size of water droplets, which pass through and therefore reduce the volume of water needing to be evaporated.

In accordance with a second embodiment, an RH sensor can be associated with one or more ceramic heating element, wherein a perimeter of the RH sensor is surrounded with a relatively conductive material. A resistive material can surround and laminate the ceramic heating element. The ceramic heating element can be configured from a porous material, wherein air that is saturated with water vapor passes through and is heated by the ceramic heating element in order to evaporate water droplets associated with the water vapor to thereby reduce relative humidity to a measurable level. One or more other heating elements can be bonded to the base of the RH sensor. The porous material forming the ceramic heating element can be formed by providing a plurality of laser drilled holes to create porosity thereof. Additionally, a filter material can be located slightly offset from the RH sensor to create a thin space of stagnant air adjacent to the RH sensor.

In accordance with a third embodiment, an RH sensor can be associated with one or more heating elements, wherein the RH sensor is surrounded by a sheet of porous resistive material in a woven or perforated pattern or state. The porous heating element can be configured to permit humid air to pass through the porous heating element. The porous heating element can be further assembled slightly offset from a surface of the RH sensor, wherein air that is saturated with water vapor passes through and is heated by the porous heating element in order to evaporate water droplets thereof to thereby reduce relative humidity to a measurable level. Additionally, a flat heating element can be bonded to the base of the RH sensor to conduct heat and insure uniform heating about the RH sensor. The porous resistive material can be formed from material such as tantalum or nichrome. A filter material can also be located slightly offset from the RH sensor to create a thin space of stagnant air adjacent to the RH sensor

In accordance with a fourth embodiment, an RH sensor can be associated with one or more heating elements, wherein a perimeter of the RH sensor is surrounded with a relatively conductive material. A thin substrate material can surround and laminate the heating element, such that the heating element is perforated to permit humid air to pass through the heating element and wherein the heating element is assembled slightly offset from a surface of the RH sensor.

An additional heating element can be bonded to a base of the RH sensor. The thin substrate material can be configured from a polymide polymer, such as Kapton® material. Additionally, a filter material can be located at vent openings in the RH sensor housing to create a relatively large space of stagnant air adjacent to the RH sensor. The filter material may be a hydrophobic material such as Goretex® which can limit the size of water droplets which pass through and therefore reduce the volume of water entering the sensor housing and needing to be evaporated.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered.

The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

1. A relative humidity sensor system, comprising:
a relative humidity sensor associated with at least one ceramic heating element, wherein a perimeter of said relative humidity sensor is surrounded with a relatively conductive material;
a resistive material surrounding said at least one ceramic heating element, wherein air that is saturated with water vapor is heated by said at least one ceramic heating element in order to evaporate water droplets associated with said water vapor to thereby reduce relative humidity to a measurable level.

2. The system of claim 1 wherein said at least one ceramic heating element comprises a porous material.

3. The system of claim 2 wherein said air that is saturated with water vapor passes through said porous material of said at least one ceramic heating element, such that said water vapor is heated by said at least one ceramic heating element in order to evaporate water droplets associated with said water vapor to thereby reduce relative humidity to a measurable level.

4. The system of claim 2 wherein said porous material of said at least one ceramic heating element comprises a plurality of laser drilled holes to create porosity thereof.

5. The system of claim 1 said at least one ceramic heating element is laminated by said resistive material.

6. The system of claim 1 further comprising at least one other heating element bonded to a base of said relative humidity sensor.

7. The system of claim 1 further comprising a filter material located slightly offset from said relative humidity sensor to create a thin space of stagnant air adjacent to said relative humidity sensor.

8. The system of claim 7 further comprising a housing and a plurality of filters formed from said filter material, wherein said housing surrounds and protects said at least one heating element and said relative humidity sensor.

9. The system of claim 8 wherein said relative humidity sensor is located on a PCB and is received by a probe comprising a temperature sensor for measuring ambient temperature.

10. The system of claim 7 wherein said filter material comprises a hydrophobic material to limit the size of water droplets associated with said humid air from passing through said at least one heating element.

11. A relative humidity sensor system, comprising:
a relative humidity sensor associated with at least one ceramic heating element configured from a porous material, wherein a perimeter of said relative humidity sensor is surrounded with a relatively conductive material;
a resistive material surrounding said at least one ceramic heating element, wherein said air that is saturated with water vapor passes through said porous material of said at least one ceramic heating element, such that said water vapor is heated by said at least one ceramic heating element in order to evaporate water droplets associated with said water vapor to thereby reduce relative humidity to a measurable level.

12. The system of claim 11 wherein said porous material of said at least one ceramic heating element comprises a plurality of laser drilled holes to create porosity thereof.

13. The system of claim 11 said at least one ceramic heating element is laminated by said resistive material.

14. A relative humidity sensing method, comprising the steps of:
providing a relative humidity sensor;
associating at least one ceramic heating element with said relative humidity sensor, wherein a perimeter of said relative humidity sensor is surrounded with a relatively conductive material;
surrounding at least one ceramic heating element with a resistive material; and
heating air that is saturated with water vapor by said at least one ceramic heating element in order to evaporate water droplets associated with said water vapor to thereby reduce relative humidity to a measurable level.

15. The method of claim 14 further comprising the step of configuring said at least one ceramic heating element to comprise a porous material.

16. The method of claim 15 wherein the step of heating air that is saturated with water vapor by said at least one ceramic heating element in order to evaporate water droplets associated with said water vapor to thereby reduce relative humidity to a measurable level, further comprises the steps of:
permitting said air that is saturated with water vapor to pass through said porous material of said at least one ceramic heating element; and
thereafter heating said water vapor with said at least one ceramic heating element in order to evaporate water droplets associated with said water vapor to thereby reduce relative humidity to a measurable level.

17. The method of claim 15 further comprising the step of providing said porous material of said at least one ceramic heating element by drilling a plurality of laser drilled holes into said at least one ceramic heating element to create porosity thereof.

18. The method of claim 14 further comprising the steps of:
laminating said at least one ceramic heating element with said resistive material; and
providing at least one other heating element bonded to a base of said relative humidity sensor.

19. The method of claim 15 further comprising the step of locating a filter material slightly offset from said relative humidity sensor to create a thin space of stagnant air adjacent to said relative humidity sensor.

20. The method of claim 19 further comprising the steps of:
providing a housing and a plurality of filters formed from said filter material, wherein said housing surrounds and protects said at least one heating element and said relative humidity sensor;
locating said relative humidity sensor on a PCB and is received by a probe comprising a temperature sensor for measuring ambient temperature; and
configuring said filter material to comprise a hydrophobic material that limits the size of water droplets associated with said humid air from passing through said at least one heating element.
